(19) United States
(12) Patent Application Publication
(10) Pub. No.: US 2008/0124586 A1
(43) Pub. Date: May 29, 2008

(54) FUEL CELL SYSTEM

(75) Inventors: Cheng Wang, Hsinchu (TW); Jin-Shu Huang, Hsinchu (TW); Ching-Po Lee, Hsinchu (TW); Nien-Hui Hsu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/853,029

(22) Filed: Sep. 11, 2007

(30) Foreign Application Priority Data
Nov. 28, 2006 (TW) 95143918

(51) Int. Cl. H01M 8/04; H01M 16/00; H01M 2/00

(52) U.S. Cl. 429/9; 429/22; 429/23; 429/24; 429/25; 429/34

(57) ABSTRACT

A fuel cell system including a fuel cell module and a pump is provided. The fuel cell module includes a membrane electrode assembly and an anode flow-channel plate disposed beside the membrane electrode assembly. The anode flow-channel plate has a reaction tank. The reaction tank is a hollow tank chamber with an inlet on its bottom and an outlet on its top. The pump is adopted for injecting an anolyte into the reaction tank from the inlet at different flow rates. When the anolyte is injected into the reaction tank by the pump, the anolyte inside the reaction tank is discharged via the outlet.

### CROSS-REFERENCE TO RELATED APPLICATION

This application claims the priority benefit of Taiwan application serial no. 95143918, filed Nov. 28, 2006. All disclosure of the Taiwan application is incorporated herein by reference.

### BACKGROUND OF THE INVENTION

1. Field of the Invention

The present invention generally relates to a battery, and more particular, to a fuel cell system.

2. Description of Related Art

Basically, a fuel cell is an electricity-generating device which takes advantage of a reverse reaction of water electrolyte to convert chemical energy into electrical energy. A direct methanol fuel cell (DMFC), a kind of fuel cells, is mainly composed of a membrane electrode assembly (MEA), an anode current-collecting plate and a cathode current-collecting plate. The MEA is composed of a proton exchange membrane, an anode catalyst layer, a cathode catalyst layer, an anode gas diffusion layer (anode GDL) and a cathode gas diffusion layer (cathode GDL). The anode catalyst layer and the cathode catalyst layer are respectively disposed at both sides of the proton exchange membrane, while the anode GDL and the cathode GDL are respectively disposed outside the anode catalyst layer and outside the cathode catalyst layer. In addition, the anode current-collecting plate and the cathode current-collecting plate are respectively disposed outside the anode GDL and outside the cathode GDL and used for collecting current and electrically connecting the fuel cell to outside.

A DMFC is supplied with methanol solution and generates current by using the related electrode reactions between methanol, oxygen and water. The chemical reaction for a DMFC are shown as follows:
at anode: CH₃OH+H₂O CO₂+6H⁺+6e⁻
at cathode: 3/2O₂+6H⁺+6e⁻→3H₂O
overall reaction: CH₃OH+H₂O+3/2O₂ CO₂+3H₂O

A DMFC further includes an anode flow-channel plate with a reaction tank, and there is a liquid flow-channel in the reaction tank to transport the methanol solution into the reaction tank for the reactions. Referring to FIG. 1, the liquid flow-channel of a conventional reaction tank 100 is a serpentine flow channel 110, wherein both ends of the serpentine flow channel 110 are respectively an inlet 112 and an outlet 114. In the prior art, a pump is employed for injecting methanol solution 50 into the reaction tank 100. Thus, the methanol solution 50 flows along the serpentine flow channel 110 and exit from the outlet 114. Since the methanol solution 50 is continuously charged, the carbon dioxide (CO₂) 60 generated by the anode reaction flows along the serpentine flow channel 110 without clogging the flow-channel and affecting the fuel cell behavior. However, once the flow rate of the methanol solution 50 is not sufficient to guide the reacted carbon dioxide away from the reaction tank 100, the carbon dioxide is retained in the flow-channel and the fuel cell efficiency is lowered drastically. In some cases, a reverse reaction occurs, which damages the MEA.

On the other hand, the electrical energy consumed by running the pump is supplemented by the fuel cell, which further lowers the net useable power output from the fuel cell. In addition, since the performance of a fuel cell is increased with an increasing reaction temperature, when the methanol solution 50 in the reaction tank 100 is continuously discharged from the outlet 114, the heat energy produced by the reaction is drawn out, which reduces the temperature and accordingly the output power. Moreover, a service life of the pump is shortened, even shorter than the lifetime of the fuel cell. Thus, the pump needs to be replaced, which causes a maintenance burden and increases the maintenance cost.

### SUMMARY OF THE INVENTION

Accordingly, the present invention is related to a fuel cell system to increase the output power.

The present invention provides a fuel cell system comprising a fuel cell module and a pump. The fuel cell module includes an anode flow-channel plate and a membrane electrode assembly (MEA) disposed beside the anode flow-channel plate. The anode flow-channel plate has a reaction tank, which is a hollow tank chamber and has an inlet located on the bottom thereof and an outlet located on the top thereof. Besides, the pump is adopted for real-time injecting an anolyte into the reaction tank via the inlet at different flow rates, and as the pump injects the anolyte into the reaction tank, the anolyte inside the reaction tank is discharged from the outlet.

According to the present invention, the anolyte is injected into the reaction tank by the pump at different flow rates so as to increase the reaction temperature and thereby increase the output power of the fuel cell system. In addition, the pump need not necessarily operate at high-speed, and therefore, the fuel cell system of the present invention is able to not only reduce the power consumption, but also increase the service life of the pump.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a diagram of a conventional reaction tank.

FIG. 2 is a diagram of a fuel cell system according to an embodiment of the present invention.

FIG. 3 is a diagram of the reaction tank of FIG. 2.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

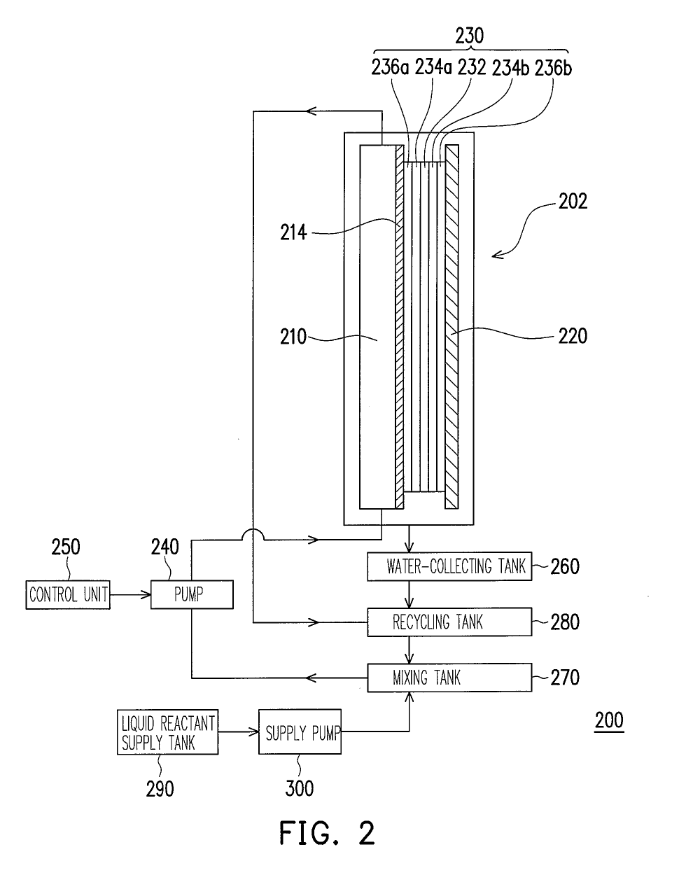

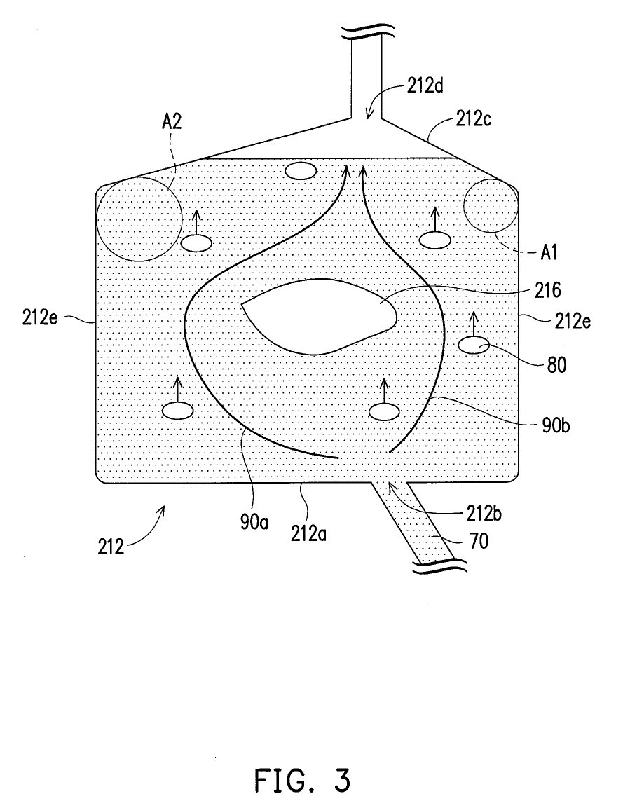

Referring to FIGS. 2 and 3, a fuel cell system 200, according to an embodiment of the present invention, includes a fuel cell module 202 and a pump 240. In the embodiment, the fuel cell system 200 is implemented exemplarily by a direct methanol fuel cell (DMFC). The pump 240 is used to provide a kind of anolyte 70 at different flow rates to the fuel cell module 202. The anolyte 70 is, for example, methanol solution, the anode reaction product of the fuel cell module 202 is, for example, carbon dioxide (CO₂) and the cathode reaction product is, for example, water (H₂O). The anolyte 70 is also ethanol, propanol or other suitable solvents.

The fuel cell module 202 includes an anode flow-channel plate 210, a membrane electrode assembly (MEA) 230, an anode current-collecting plate 214 and a cathode current-collecting plate 220. The MEA 230 is disposed beside the anode flow-channel plate 210. The anode flow-channel plate 210 has a reaction tank 212, which has an inlet 212b located at the bottom 212a of the reaction tank 212 and an outlet 212d located on the top 212c thereof. The anode current-collecting plate 214 is disposed between the anode flow-channel plate 210 and the MEA 230, while the MEA 230 is disposed between the anode current-collecting plate 214 and the cathode current-collecting plate 220.

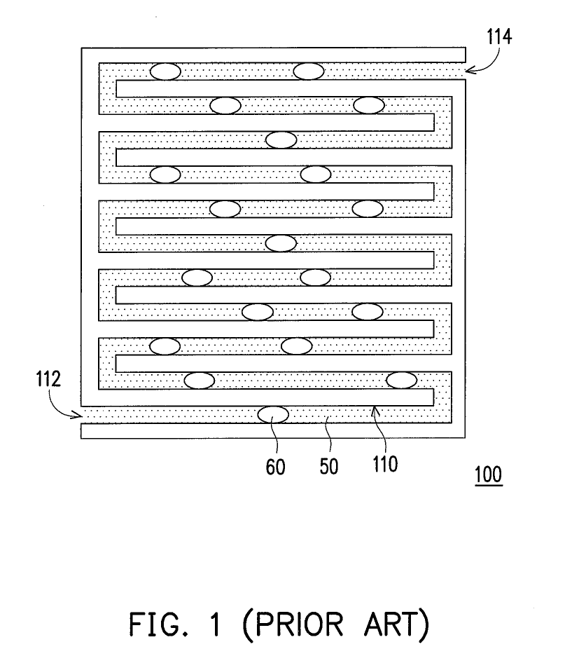

It should be noted that, the anolyte 70 is not continuously injected, and if the conventional reaction tank 100 (as shown by FIG. 1) is adopted by the present embodiment, the anode reaction product clogs the flowing-channel. Therefore, the reaction tank 212 adopted by the present embodiment is accordingly a hollow tank chamber (as shown by FIG. 3). In this way, the generated anode reaction product (for example, carbon dioxide 80) is gathered on the liquid surface of the anolyte 70 based on the floating action. While the reactions continue, the anolyte 70 is consumed continuously decreasing the liquid level thereof. The vacant space inside the reaction tank 212 is available for the carbon dioxide 80 to occupy.

In order to accumulate the fluid (for example, carbon dioxide 80 or anolyte 70) at the outlet 212d to facilitate easy discharge out of the reaction tank 212, the top 212c of the reaction tank 212 extends from a sidewall 212e of the reaction tank along a direction departing from the bottom 212a of the reaction tank and gradually reduces to the outlet 212d. Besides, a flow-guiding block 216 is disposed in the reaction tank 212 to make the fluid inside the reaction tank 212 flow roughly in the directions indicated by arrow marks 90a and 90b. It should be noted that that after the operation of the pump 240 is started, the flow of the anolyte 70 after entering the reaction tank 212 is rendered unstable, which contributes to overcome the problem accumulation of the byproduct produced by the reactions in some dead areas (for example, areas A1 and A2).

The anode current-collecting plate 214 is, for example, a porous current-collecting plate. When the anode reaction product is produced in the permeable holes (not shown) of the anode current-collecting plate 214, the anode reaction product moves from the MEA 230 based on the floating action and arrive at the upper portion or on the sidewall of the reaction tank 212 without blocking the flow-channel. In the end, the anode reaction product is discharged out of the fuel cell module 202 via the outlet 212d at the upper portion of the reaction tank 212. The anode current-collecting plate 214 is comprised of a conductive material, for example, titanium or titanium alloy, or any metal treated with an anti methanol-corrosion process, or a porous current-collecting plate (plated in gold) fabricated by using a stacked circuit board process. The cathode current-collecting plate 220 is, for example, a porous current-collecting plate having a plurality of permeable holes.

The MEA 230 includes a proton exchange membrane 232, an anode catalyst layer 234a, a cathode catalyst layer 234b, an anode gas diffusion layer (anode GDL) 236a and a cathode gas diffusion layer (cathode GDL) 236b. The anode catalyst layer 234a and the cathode catalyst layer 234b are respectively disposed at two sides of the proton exchange membrane 232, the anode GDL 236a is disposed between the anode catalyst layer 234a and an anode 210, while the cathode GDL 236b is disposed between the cathode catalyst layer 234b and a cathode 220. The anode GDL 236a and the cathode GDL 236b may be comprised of carbon. The anode catalyst layer 234a is comprised of, for example, platinum/ruthenium (Pt/Ru) alloy, carbon particulates plated in platinum/ruthenium alloy, carbon particulates plated in platinum or other appropriate materials. The cathode catalyst layer 234b is comprised of, for example, platinum alloy, carbon particulates plated in platinum alloy, carbon particulates plated in platinum or other appropriate materials. The proton exchange membrane 232 serves as an electrolyte membrane to transport the protons of hydrogen and the proton exchange membrane 232 is comprised of, for example, macromolecule membrane.

The anode catalyst layer 234a catalyzes the anolyte 70 to reaction, for example, in methanol solution, the anode catalyst layer 234a catalyzes the hydrogen atoms contained by the methanol to split into protons (H⁺) and electrons (e⁻). Meanwhile, carbon dioxide (i.e. the anode reaction product) is produced at the side of the anode current-collecting plate 214. On the other hand, air enters via the permeable holes of the cathode current-collecting plate 220, then passes through the cathode GDL 236b and arrives at the cathode catalyst layer 234b, while the protons (H⁺) migrate to the side of the cathode catalyst layer 234b. The electrons (e⁻) move from the external circuit to the side of the cathode catalyst layer 234b and generate water (i.e. the cathode reaction product) after combining the oxygen provided by the air. After that, the cathode reaction product is discharged into a water-collecting tank 260 connected to the fuel cell module 202 from the fuel cell module 202.

The pump 240 is connected between the fuel cell module 202 and a mixing tank 270. The pump 240 is used for injecting the anolyte 70 in the mixing tank 270 into the reaction tank 212 alternately at a first flow rate and a second flow rate via the inlet 212b, wherein the second flow rate is lower than the first flow rate. In the present embodiment, the pump 240 rotates, for example, alternately in a first rotation speed and a second rotation speed lower than the first rotation speed, so that the anolyte 70 in the mixing tank 270 is injected into the reaction tank 212 via the inlet 212b alternately at the first flow rate and the second flow rate. As the pump 240 rotates in the first rotation speed (corresponding to the first flow rate), the volume of the anode reaction product injected into the reaction tank 212 is roughly equal to the volume of the reaction tank 212 or that in which the anolyte just overflows the anode current-collecting plate 214 of the MEA 230. The second rotation speed is, for example, the lowest rotation speed or the zero rotation speed of the pump 240, wherein when the second rotation speed is the zero rotation speed, the second flow rate is zero. When the pump 240 injects the anolyte 70 into the reaction tank 212, the anolyte 70 originally retained in the reaction tank 212 is discharged from the outlet 212d and stored in a recycling tank 280. In more detail, the recycling tank 280 is connected between the water-collecting tank 260 and the mixing tank 270, and the mixing tank 270 is connected to a liquid reactant supply tank 290. When the concentration of the anolyte in the mixing tank 270 is lower than a standard concentration, a supply pump 300 connected between the mixing tank 270 and the liquid reactant supply tank 290 is driven, so as to inject the anolyte with higher concentration into the mixing tank 270 to increase the concentration of the anolyte.

In the present embodiment, the fuel cell system 200 further includes, for example, a control unit 250 electrically connected to the pump 240. The control unit 250 is adopted for controlling an operation of the pump 240, so that the anolyte 70 is injected into the reaction tank 212 via the inlet 212b alternately at the first flow rate and the second flow rate. In other words, compared to the prior art where a pump with a fixed flow rate is adopted to continuously inject the anolyte into the reaction tank, the present invention proposes operating the pump 240 to inject anolyte 70 at a first flow rate until the anolyte 70 fills the reaction tank 212, and then the speed of the pump 240 reduces such that the anolyte 70 is injected at the second flow rate, i.e. in a lower flow rate. After continuing the reaction for a predetermined period of time, the speed of the pump 240 returns to pump the anolyte 70 at the first flow rate to inject the anolyte 70 into the reaction tank 212.

In the present embodiment, the control unit 250 controls the pump 240 to inject the anolyte 70 into the reaction tank 212 periodically (for example, every couple of minutes). In another embodiment, a concentration detector (not shown) is disposed in the reaction tank 212 and electrically connected to the control unit 250. The concentration detector is used for detecting the concentration of the anolyte 70, while the control unit 250 controls the operation of the pump 240 according to the concentration of the anolyte 70. When the concentration of the anolyte 70 drops down to a minimum standard value, the control unit 250 starts the pump 240 to inject the anolyte 70 into the reaction tank 212. In another embodiment, a liquid level detector (not shown) is disposed in the reaction tank 212 for detecting the liquid level of the anolyte 70 in the reaction tank 212. The liquid level detector is electrically connected to the control unit 250, and the control unit 250 controls the operation of the pump 240 according to the liquid level of the anolyte 70 in the reaction tank 212. When the liquid level of the anolyte 70 drops down to a lower limit value, the control unit 250 starts the pump to inject the anolyte 70 into the reaction tank 212.

In another embodiment, the control unit 250 controls the operation of the pump 240 according to an output power of the fuel cell system 200. For example, assuming the original output power of the fuel cell system 200 is 12 W, when the output power falls to 11.5 W, the control unit 250 starts the pump 240 to inject the anolyte 70 into the reaction tank 212. In another embodiment, the control unit 250 controls the operation of the pump 240 according to an output energy of the fuel cell system 200. For example, when the output energy of the fuel cell system 200 reaches a predetermined watt-hour, the control unit 250 starts the pump 240 to inject the anolyte 70 into the reaction tank 212 at the first flow rate.

In another embodiment, the control unit 250 controls the operation of the pump 240 according to the temperature of the fuel cell system 200. For example, the fuel cell system 200 further includes at least a temperature sensor (not shown) electrically connected to the control unit 250 and the control unit 250 controls the operation of the pump 240 according to the detection result of the temperature sensor. The place where the temperature sensor is disposed is termed as a temperature feedback point. The temperature sensor is disposed inside the reaction tank 212, adjacent the MEA 230, or in contact with the MEA 230 or at other appropriate place. In this way, the control unit 250 controls the operation of the pump 240 according to the feedback result of the temperature sensor. If the temperature value measured at the temperature feedback point is lower than or higher than a predetermined temperature value, the control unit 250 starts the pump 240. For example, when the temperature sensor is disposed inside the reaction tank 212 and the successive five temperature values measured by the temperature sensor indicate a decreasing pattern of the temperature, it means the heat generated by the reaction has reached a preset peak value, the control unit 250 starts the pump 240 to inject the anolyte 70 into the reaction tank 212. Besides, if the temperature value measured by the temperature sensor disposed inside the reaction tank 212 is higher than the temperature value of the anolyte 70 measured by the temperature sensor disposed at the inlet 212b (for example, higher by 5° C.), the control unit 250 starts the pump 240 to inject the anolyte 70 into the reaction tank 212 at the first flow rate.

The control unit 250 also controls operation of the pump 240 to start according to an amount of a cathode reaction product generated during the anolyte reacting at the MEA 230. For example, a liquid level detector (not shown) is disposed in the water-collecting tank 260, and the liquid level detector is electrically connected to the control unit 250. When the liquid level of the water-collecting tank 260 reaches a predetermined increasing amplitude, the liquid level detector informs the control unit 250 to start the pump 240 to inject the anolyte 70 into the reaction tank 212 at the first flow rate. In addition, a weight detector or a hydraulic pressure sensor is adopted to detect the volume of the liquid inside the water-collecting tank 260.

In the present invention, the control unit 250 also controls the operation of the pump 240 according to the pressure variation of the anode reaction product generated during the anolyte reacting at the MEA 230 in the fuel cell system 200. For example, a throttle gas valve (not shown) is disposed at the outlet 212d on the top of the reaction tank 212. When the anolyte 70 is pumped into the reaction tank 212, the throttle gas valve shuts off immediately to make the reaction tank 212 an air-tight tank. In addition, a pressure sensor (not shown) is disposed at the upper portion of the reaction tank 212. When the pressure of the anode reaction product reaches a certain value, the control unit 250 starts the pump 240 to inject the anolyte 70 into the reaction tank 212 at the first flow rate.

In the present invention, a collection tank (not shown) is further used and disposed outside the fuel cell module 202 for collecting the anode reaction product. At the outlet of the collection tank, a throttle gas valve (not shown), or alternatively a relief gas valve (not shown), is disposed. Meanwhile, a pressure sensor (not shown) is disposed in the collection tank and the pressure sensor is electrically connected to the control unit 250. When the anolyte 70 is injected into the reaction tank 212, the throttle gas valve (or the relief gas valve) shuts off immediately. When the pressure of the anode reaction product reaches a certain value, the control unit 250 starts the pump 240 to inject the anolyte 70 into the reaction tank 212 at the first flow rate.

In another embodiment, the control unit 250 controls the pump 240 according to a voltage by comparing a voltage of an open-circuit voltage of the MEA 230 in the fuel cell system 200 with a predetermined voltage. For example, when the anolyte 70 is injected into the reaction tank 212, a voltage detector immediately measures an open-circuit voltage V₀. After a period of time, when the measured open-circuit voltage is lower than V₀, the control unit 250 is informed to start the pump 240 to inject the anolyte 70 into the reaction tank 212 at the first flow rate. Alternatively, when the anolyte 70 is injected into the reaction tank 212, the open-circuit voltage is measured continuously, wherein if the successive five voltage readings indicate a gradually decreasing voltage trend in addition to another condition to meet that the trend is given for three times within a predetermined time length (for example, within one minute), the result indicates that the overall output power has reached the peak value. At this time, the control unit 250 is informed to start the pump 240 to inject the anolyte 70 into the reaction tank 212 at the first flow rate.

The fuel cell system 200 further includes, for example, a secondary battery (not shown), which provides power during detection of the open-circuit voltage of the fuel cell module 202 while the fuel cell module 202 ceases to supply the external load with electricity. The secondary battery is able to provide the external load with at least a part of power during the operation thereof. The secondary battery is a super capacitor or a lithium-ion battery.

In another embodiment, the control unit 250 controls the pump 240 to start according to a weight variation of the fuel cell module 202 in the fuel cell system 200. For example, when the anolyte 70 is pumped into the reaction tank 212, an anode reaction product and a cathode reaction product are produced. The anode reaction product is discharged from the outlet 212d and the cathode reaction product is transferred by a circulation fan (not shown) or collected into the water-collecting tank 260, which causes the weight variation of the fuel cell module 202. Thus, based on the fact, the fuel cell system 200 further includes a weight detector for detecting the weight of the fuel cell module 202 and the weight detector is electrically connected to the control unit 250. When the weight is lower than a predetermined value, the control unit 250 starts the pump 240 to inject the anolyte 70 into the reaction tank 212 at the first flow rate.

Since the pump 240 injects the anolyte 70 into the reaction tank 212 alternately at the first flow rate and the second flow rate, therefore the power consumption of the pump 240 is effectively reduced, which further contributes to conserve the net output power of the fuel cell system 200. In addition, the life service of the pump 240 is prolonged, so that the maintenance cost is accordingly reduced. Further, since the pump 240 is not in durative high-speed operation, the noise is effectively reduced. Moreover, during the reaction, the anolyte 70 and the heat generated are not continuously discharged from the outlet 212d, and therefore the heat energy produced by the reaction is effectively utilized to increase the reaction temperature, which further promotes the output power of the fuel cell system 200.

In the following, some testing data during an operation period of the fuel cell system 200 of the embodiment and the conventional fuel cell are given. For the conventional fuel cell, the effective output power is about 10.23 W, while the temperature of the anolyte output from the outlet is about 38° C. For the fuel cell system 200 of the present embodiment, the effective output power is about 11.55 W, while the temperature of the anolyte 70 output from the outlet 212d is about between 45° C. and 48° C. In addition, the average consumption power of the on-duty pump 240 is about 0.8 W, assuming that the pump 240 of the present embodiment runs for 10 seconds at every 8 minutes time interval, the real average power consumption is far lower than 0.1 W. Therefore, the available net output power of the fuel cell system 200 provided by the embodiment is over 120% over the corresponding power provided by the prior art.

In summary, the present invention has at least one or more of the following advantages:

1. In the present invention, the pump is used to inject the anolyte into the reaction tank alternately at a first flow rate and a second flow rate, so that during the reaction, the output amount of the depleted anolyte from the outlet is reduced, which further reduces the heat energy loss, so as to advantageously increase the reaction temperature and accordingly promotes the output power of the fuel cell.

2. Since the pump does not continuously run in high-speed, the noise is reduced and the power consumption is reduced, which contributes to conserve net output power of the fuel cell system in addition to prolonging the service life of the pump and reduces the maintenance cost.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell system, comprising:
a fuel cell module, comprising:
an anode flow-channel plate, having a reaction tank, wherein the reaction tank is a hollow tank chamber and has at least an inlet and at least an outlet; and
a membrane electrode assembly, disposed beside the anode flow-channel plate; and
a pump, connected to the fuel cell module, wherein the pump is adopted for injecting an anolyte into the reaction tank via the inlet at different flow rates, and as the pump injects the anolyte into the reaction tank, the anolyte inside the reaction tank is discharged from the outlet.

2. The fuel cell system according to claim 1, wherein a top of the reaction tank extends from a sidewall of the reaction tank along a direction departing from a bottom of the reaction tank and gradually reduces to the outlet.

3. The fuel cell system according to claim 1, wherein a flow-guiding block is disposed in the reaction tank.

4. The fuel cell system according to claim 1, wherein the pump injects the anolyte into the reaction tank via the inlet alternately at a first flow rate and a second flow rate, and the second flow rate is lower than the first flow rate.

5. The fuel cell system according to claim 1, further comprising a control unit electrically connected to the pump, wherein the control unit is adopted for controlling the pump.

6. The fuel cell system according to claim 5, wherein a concentration detector is disposed in the reaction tank to detect a concentration of the anolyte, the concentration detector is electrically connected to the control unit, and the control unit controls the pump according to the concentration of the anolyte.

7. The fuel cell system according to claim 5, wherein a liquid level detector is disposed in the reaction tank to detect a liquid level of the anolyte in the reaction tank, the liquid level detector is electrically connected to the control unit, and the control unit controls the pump according to the liquid level of the anolyte in the reaction tank.

8. The fuel cell system according to claim 5, wherein the control unit controls the pump according to an output power of the fuel cell system.

9. The fuel cell system according to claim 5, wherein the control unit controls the pump according to an output energy of the fuel cell system.

10. The fuel cell system according to claim 5, further comprising a temperature sensor electrically connected to the control unit, wherein the temperature sensor is disposed in the reaction tank or adjacent to the membrane electrode assembly, or in contact with the membrane electrode assembly, and the control unit controls the pump according to a temperature measured by the temperature sensor.

11. The fuel cell system according to claim 5, wherein the control unit controls the pump according to an amount of a cathode reaction product generated during the anolyte reacting at the membrane electrode assembly.

12. The fuel cell system according to claim 11, further comprising a collecting tank and a liquid level detector disposed in the collecting tank, wherein the collecting tank is connected to the fuel cell module, the cathode reaction product is discharged into the collecting tank and the liquid level detector is electrically connected to the control unit.

13. The fuel cell system according to claim 11, further comprising a collecting tank and a weight detector or a hydraulic pressure sensor disposed in the collecting tank, wherein the collecting tank is connected to the fuel cell module, the cathode reaction product is discharged into the collecting tank, and the weight detector or the hydraulic pressure sensor is electrically connected to the control unit.

14. The fuel cell system according to claim 5, wherein the control unit controls the pump according to a pressure variation of a cathode reaction product generated during the anolyte reacting at the membrane electrode assembly.

15. The fuel cell system according to claim 14, further comprising a collection tank, a pressure sensor disposed in the collection tank and a throttle gas valve or a relief gas valve disposed at an outlet of the collection tank, wherein the collection tank is adopted for collecting the anode reaction product and the pressure sensor is electrically connected to the control unit.

16. The fuel cell system according to claim 5, wherein the control unit controls the pump according to an open-circuit voltage of the membrane electrode assembly.

17. The fuel cell system according to claim 5, wherein the control unit controls the pump according to a weight variation of the fuel cell module.

18. The fuel cell system according to claim 17, further comprising a weight detector for sensing a weight of the fuel cell, wherein the weight detector is electrically connected to the control unit.

19. The fuel cell system according to claim 1, wherein the membrane electrode assembly comprises a proton exchange membrane, an anode catalyst layer, a cathode catalyst layer, an anode gas diffusion layer and a cathode gas diffusion layer, wherein the anode catalyst layer and the cathode catalyst layer are respectively disposed at two sides of the proton exchange membrane, the anode gas diffusion layer is disposed between the anode catalyst layer and an anode, and the cathode gas diffusion layer is disposed between the cathode catalyst layer and a cathode.

20. The fuel cell system according to claim 1, further comprising a secondary battery, wherein when an open-circuit voltage of the membrane electrode assembly is detected and the membrane electrode assembly ceases to provide electricity to an external load, and the secondary battery provides electricity to the external load.

21. The fuel cell system according to claim 1, wherein the fuel cell module further comprises:
an anode current-collecting plate, disposed between the anode flow-channel plate and the membrane electrode assembly; and
a cathode current-collecting plate, wherein the membrane electrode assembly is disposed between the anode current-collecting plate and the cathode current-collecting plate.
